(19) United States
(12) Patent Application Publication
(10) Pub. No.: US 2012/0098630 A1
(43) Pub. Date: Apr. 26, 2012

(54) CYLINDRICAL PERMANENT MAGNET DEVICE WITH AN INDUCED MAGNETIC FIELD HAVING A PREDETERMINED ORIENTATION, AND PRODUCTION METHOD

(76) Inventors: Dimitrios Sakellariou, Boulogne Billancourt (FR); Cédric Hugon, Oxfordshire (GB); Guy Aubert, Poitiers (FR)

(21) Appl. No.: 13/063,861

(22) PCT Filed: Aug. 27, 2010
(86) PCT No.: PCT/FR2010/051781

§ 371 Date: Nov. 22, 2011

(30) Foreign Application Priority Data
Aug. 28, 2009 (FR) 0955889

(51) Int. Cl. H01F 7/02; H01F 41/02

(52) U.S. Cl. 335/302; 29/607

(57) ABSTRACT

A cylindrical permanent magnet device that induces in a central area of interest a homogeneous magnetic field of predetermined orientation relative to a longitudinal axis (z) of the device comprises first and second annular magnetized structures (111, 121) disposed symmetrically relative to a plane (P) that is perpendicular to the longitudinal axis (z) and contains the central area of interest, and a third annular magnetized structure (112, 122) disposed between the first and second structures (111, 121) and also disposed symmetrically relative to the plane (P) of symmetry. The first, second, and third annular magnetized structures (111, 121, 112, 122) are divided into components in the form of sectors. The third annular magnetized structure (112, 122) is divided into at least two slices (112A, 112B, 122A, 122B) along the longitudinal axis (z) and in that all the components of the first, second and third annular magnetized structures (111, 121, 112, 122) are magnetized in the same direction to create in the central area of interest a homogeneous induced magnetic field at a predetermined angle to the longitudinal axis (z). The parts of the device may be assembled before the assembly is magnetized.

### FIELD OF THE INVENTION

The present invention relates to a cylindrical permanent magnet device that induces in a central area of interest a homogeneous magnetic field of predetermined orientation relative to a longitudinal axis of the device, the device comprising first and second annular magnetized structures disposed symmetrically relative to a plane that is perpendicular to said longitudinal axis and that contains said central area of interest, and a third annular magnetized structure disposed between the first and second structures and also disposed symmetrically relative to said plane, the first, second, and third annular magnetized structures being each divided into a plurality of components in the form of regularly distributed identical sectors.

The invention also relates to a method of producing such a permanent magnet device.

### PRIOR ART

In the field of nuclear magnetic resonance (NMR), the sample (object or patient) is placed inside a magnetic field that must be very intense and very homogeneous. It is therefore necessary to be able to manufacture magnetized structures capable of producing such magnetic fields.

Moreover, it is often useful to be able to produce a magnetic field in a predetermined direction. For example, in order to improve resolution, in the magic angle spinning (MAS) technique a sample is made to spin rapidly at a so-called magic angle (equal to 54 degrees 44 minutes) to the direction of the static magnetic field.

The magnets used at present in NMR to create intense and homogeneous fields are for the most part based on the flow of current in windings. Whether the windings are resistive or superconducting, it is always necessary to supply the magnet with current and also with cryogenic fluids for superconducting windings. Because of this, the devices are bulky and difficult to move. Resistive windings require high-current feeds, while superconducting windings imply the use of a cryostat filled with cryogenic liquids, which is difficult to move.

A structure based on permanent magnets makes it possible to circumvent those constraints because the material is magnetized once and for all and, if it is manipulated appropriately, retains its magnetization without exterior maintenance. Moreover, so-called permanent materials are limited in terms of remanence (the magnetization remaining in the material once magnetized) and generating high fields in large areas of use requires large quantities of material. Since the density of these materials is approximately 7.5 g·cm⁻³, these systems quickly become very heavy. It is therefore important to minimize the quantity of material for a given field.

The difficulty with magnetic systems using permanent materials for NMR lies in the requirement to combine intense fields with high homogeneity. The methods of producing materials such as NdFeB cannot guarantee perfect homogeneity of magnetization or perfect repetitivity. Also, although it is possible to calculate structures providing the required homogeneity, it is necessary to provide for the possibility of a posteriori adjustments for correcting imperfections of the material.

The overall shape of those magnetized structures is generally cylindrical, where the structure has at least axial symmetry. That makes it possible to circumvent numerous factors of inhomogeneity. The area of interest is then at the center of the cylinder and access to this area may be effected along the axis by opening up a hole in the cylinder, or from the side by splitting the cylinder in two.

In the past, very few structures based on permanent magnets have been proposed for generating a homogeneous longitudinal field at the center. This is because the NMR applications that require high homogeneity also require the devices to be either very large (in MRI where a human body must be placed inside the device), which implies an enormous quantity of material (several tons), or very intense (in NMR spectroscopy, which uses fields exceeding 10 teslas (T), at present up to 20 T), which is simply not feasible at present with permanent materials.

The earliest patent relating to a cylindrical permanent magnet structure generating a homogeneous longitudinal field suitable a priori for NMR is that of Guy Aubert dating from 1991 (U.S. Pat. No. 5,014,032). That proposes using rings of permanent material magnetized radially. The rings are magnetized towards the axis of symmetry on one side of the useful area and outwards on the other side of the useful area. The structure is symmetrical relative to the plane orthogonal to the axis of symmetry and containing the center of the useful area.

Nowadays there is renewed interest in structures based on permanent materials because they are very suited to portable or transportable low-field NMR applications. Moreover, new magnetic materials offer much higher remanence and coercivity, making possible induced fields sufficient for applications in NMR (hundreds of milliteslas (mT)). Finally, these materials lend themselves readily to rotation, which should make it possible to obtain an improvement in resolution, as in the method proposed by Bloch (U.S. Pat. No. 2,960,649), this time by spinning the field, not the sample.

In 2006 Heninger et al. proposed a structure for generating a longitudinal field in the context of an ion trap (patent application WO 2006/024775). That magnet makes possible homogeneity of one per thousand in a volume of 10 cubic centimeters (cm³) with a field of 1 T. That structure therefore does not make possible homogeneity as required for NMR, but produces a field comparable in magnitude to that of certain medical imaging devices (1.5 T).

Moreover, Halbach (K. Halbach, “Design of permanent multipole magnets with oriented rare earth cobalt material”, Nuclear Instruments and Methods, vol. 169, pp. 1-10, 1980) has proposed cylindrical structures making it possible to create any multipole with perfect homogeneity, but only for a magnet that is theoretically of infinite length. The best known Halbach multipole is the dipole, which generates an arbitrarily intense field transverse to the axis of the cylinder by increasing the ratio of the outside radius to the inside radius (this is limited by the coercivity of the material used). The Halbach structure is exact in two dimensions (implying that the structure is of infinite size in the third dimension) and requires continuous variation of the orientation of the magnetization in the material. These two conditions cannot be achieved in practice. In contrast, the orientation of the magnetization may be divided into discrete sectors. With a 2D structure, using a sufficient number of sectors makes it possible to obtain homogeneity to an arbitrarily chosen order. The three-dimensional aspect of the structure then makes it necessary to take account of edge effects and implies modification of the geometry to obtain the required homogeneity. This has given rise to diverse applications.

Those applications include the work of Callaghan et al., who have proposed a method of producing Halbach structures from cubic magnets (patent application WO 2007/120057). The resulting structure makes it possible to eliminate the second order terms, which rules out sufficient homogeneity for use in NMR.

Miyata (U.S. Pat. No. 5,148,138) has also proposed a method of producing homogeneous Halbach structures for NMR. U.S. Pat. No. 5,148,138 relates essentially to the use of ferrite and rare earths to optimize the weight and cost of the magnet.

Holsinger (patent application WO 88/10500) has also described an alternative production method using hollow rods to contain the magnetized material. The rods are disposed axisymmetrically and filled with pieces of permanent magnets magnetized in the right direction. The rods are segmented to adjust the homogeneity.

In addition to Halbach structures, Guy Aubert has proposed another type of structure creating a homogeneous transverse field (U.S. Pat. No. 4,999,600). That structure allows access to the center along the axis of symmetry. In U.S. Pat. No. 5,332,971, Aubert has subsequently proposed another type of structure offering a high homogeneous field at its center. That allows transverse access to the useful area. That structure uses two complementary sets of rings disposed on respective opposite sides of the useful area.

Finally, Leupold (U.S. Pat. No. 5,523,732) has drawn inspiration from the Halbach structure to propose a system allowing adjustment of the direction (in the transverse plane) and intensity of the field created at the center.

There has also been renewed interest in homogeneous structures based on permanent magnets in the context of rotating field NMR (R. D. Schlueter and T. F. Budinger, “Magic angle rotating field NMR/MRI magnet for in vivo monitoring of tissue”, IEEE Transactions on Applied Superconductivity, vol. 18(2), p. 864-867, June 2008). That follows on from the discovery of the possibility of spinning at low speed (tens of hertz (Hz) as against tens of kilohertz (kHz) in standard sample rotation) to improve resolution (R. A. Wind, J. Z. Hu, and D. N. Rommereim, “High resolution ¹H NMR spectroscopy in organs and tissues using slow magic angle spinning”, Magnetic Resonance in Medicine, vol. 46, p. 213-218, 2001). That advance relates to obtaining the benefit of high-resolution spectra in samples that cannot be spun at the usual MAS speeds. With a human being in particular, it is inconceivable to rotate a person in the device. Also, rotating the field relative to the subject under study may prove particularly interesting by providing access to high resolution in anisotropic media without rotating the subject. Rotating field NMR exploration does not require extremely intense fields. In contrast, it is necessary to face up to the technological challenge of rotating the device generating the field at between 1 Hz and 10 Hz. In this regard permanent materials are the most appropriate because they do not require feeding with electricity or cryogenic liquids.

Until now, no permanent magnet structure has been proposed to enable the generation of an arbitrarily homogeneous field at an arbitrary angle to the axis of the structure. The solutions that have found applications have essentially consisted in interleaving a permanent magnet of the Halbach type generating a transverse field into an electromagnet generating a longitudinal field. The Halbach magnet is rotated inside the electromagnet, thereby rotating the field. It is of course necessary to decide beforehand the ratio B_{electromagnet}/B_{Halbach} to obtain the required angle. There is at present no proposal for generating a homogeneous field at an arbitrary angle only from magnetized parts, especially since manipulating magnetized parts to assemble them proves difficult given all the forces linked to the magnetism of the parts, which may be extremely intense when assembling large parts.

### DEFINITION AND OBJECT OF THE INVENTION

The present invention aims to remedy the drawbacks referred to above and in particular to offer a solution to the problem of assembling magnetized parts to form powerful permanent magnets capable of creating a homogeneous and intense field at the center of the magnetized structure, the induced field being oriented along the longitudinal axis of the structure.

The invention may find applications inter alia in the fields of “light” NMR or rotating field MRI-NMR.

Generally speaking, the present invention aims to make it possible to produce a magnetized structure that induces at its center a homogeneous field in the longitudinal direction or at an arbitrary angle.

The invention achieves the above aims in a cylindrical permanent magnet device that induces in a central area of interest a homogeneous magnetic field of predetermined orientation relative to a longitudinal axis (z) of the device, the device comprising first and second annular magnetized structures disposed symmetrically relative to a plane (P) that is perpendicular to said longitudinal axis (z) and that contains said central area of interest, and a third annular magnetized structure disposed between the first and second structures and also disposed symmetrically relative to said plane (P), the first, second, and third annular magnetized structures being each divided into a plurality of components in the form of regularly distributed identical sectors, the device being characterized in that the third annular magnetized structure is divided into at least two slices along the longitudinal axis (z) and in that all the components of the first, second and third annular magnetized structures at a predetermined first angle θ₁ to said longitudinal axis (z) are magnetized in the same direction to create in said central area of interest a homogeneous induced magnetic field at a predetermined second angle θ₂ to said longitudinal axis (z).

In one particular embodiment said predetermined second angle θ₂ is zero and all the sector-shaped components are magnetized along the longitudinal axis.

According to another advantageous embodiment said predetermined second angle θ₂ is equal to the magic angle of 54.7° and all the sector-shaped components are magnetized in the same direction inclined at 109.47° to said longitudinal axis.

According to a preferred embodiment the third annular magnetized structure is divided into at least four slices.

According to the invention the predetermined first angle θ₁ and the predetermined second angle θ₂ are determined by the following formulas:

$$sin {θ}_{1} = \frac{2 sin {θ}_{2}}{\sqrt{1 + 3 {sin}^{2} {θ}_{2}}} , \\ cos {θ}_{1} = - \frac{cos {θ}_{2}}{\sqrt{1 + 3 {sin}^{2} {θ}_{2}}} , \\ sin {θ}_{2} = \frac{sin {θ}_{1}}{\sqrt{1 + 3 {cos}^{2} {θ}_{1}}} , \\ cos {θ}_{2} = - \frac{2 cos {θ}_{1}}{\sqrt{1 + 3 {cos}^{2} {θ}_{1}}} ,$$

According to one particular embodiment the first and second annular magnetized structures and each slice of the third annular magnetized structure are divided into at least twelve components in the form of identical sectors.

According to a preferred feature the first and second annular magnetized structures have in the direction of the longitudinal axis a thickness greater than that of each slice of the third annular magnetized structure.

To facilitate production the interior and exterior cylindrical walls of the first, second, and third annular magnetized structures have a polygonal section in a plane perpendicular to said longitudinal axis.

According to one particular embodiment all the components of the first, second, and third annular magnetized structures are contiguous, which simplifies production by optimizing efficacy. However, although the device of the invention makes convenient and accurate assembly possible, in some particular circumstances, it is equally possible to have a device with at least one annular magnetized structure that comprises a set of regularly distributed non-contiguous identical components. Under these circumstances, there is the possibility of fine adjustment a posteriori by changing the precise positioning of some of the non-contiguous components.

The invention also relates to a device in which the interior and exterior cylindrical walls of the first, second, and third annular magnetized structures have a circular section in a plane perpendicular to said longitudinal axis to define an axisymmetrical structure.

The invention also relates to a method of manufacturing a device as defined above that comprises the following steps:

a) manufacturing identical sector-shaped components from a magnetizable but non-magnetized material;

b) assembling said sector-shaped components to form non-magnetized first and second annular structures symmetrically disposed relative to a plane that is perpendicular to a longitudinal axis and contains a central area of interest, and to form a non-magnetized third median annular structure disposed between the first and second structures and also symmetrically disposed relative to said plane perpendicular to the longitudinal axis and containing the central area of interest; and

c) subjecting all the components of the first, second, and third non-magnetized annular structures to the action of the magnetic field of an exterior auxiliary magnet up to saturation point to magnetize all the components of the first, second, and third annular structures in the same direction at a first predetermined angle θ₁ relative to the longitudinal axis z so that the permanent magnetic device produced by the method is able to create in said central area of interest a homogeneous and intense induced magnetic field at a second predetermined angle θ₂ to said longitudinal axis.

With such a method, assembly is facilitated and may be very accurate because it is carried out on non-magnetized parts exerting no forces between them, so that subsequent adjustments are of no utility or very minor, and the structure may be produced in a simplified manner, for example with contiguous parts. Moreover, the choice of the same orientation for all the elementary parts allows such magnetization after assembly.

### BRIEF DESCRIPTION OF THE DRAWINGS

Other features and advantages of the invention emerge from the following description of particular embodiments given by way of example with reference to the appended drawings, in which:

FIG. 1 is a diagrammatic overall perspective view of a cylindrical permanent magnetic device of the invention;

FIG. 2 is a perspective view of a polygonal section cylindrical permanent magnetic device of one embodiment of the invention;

FIG. 3 is a top view showing one possible form of polygonal structure divided into sectors of trapezoidal shape;

FIG. 4 is a diagrammatic representation of the magnetization orientation of the different components of one example of a longitudinal induced field magnetic device of the invention; and

FIG. 5 is a diagrammatic representation of the magnetization orientation of the different components of another example of a magnetic device of the invention with an induced field oriented at the so-called magic angle.

### DETAILED DESCRIPTION OF PREFERRED EMBODIMENTS

Generally speaking, the present invention relates to a method of assembling magnetized parts to create an intense and homogeneous magnetic field at the center of the structure. The field induced at the center is at an angle to the axis of the structure. This angle may be chosen arbitrarily between 0 and 90 degrees by appropriate choice of the orientation of the magnetization of the parts of the assembly. The field obtained may be rendered arbitrarily homogeneous by choosing the number and dimensions of the elements in accordance with certain general rules that are discussed below. Such a structure is particularly interesting for NMR and MRI.

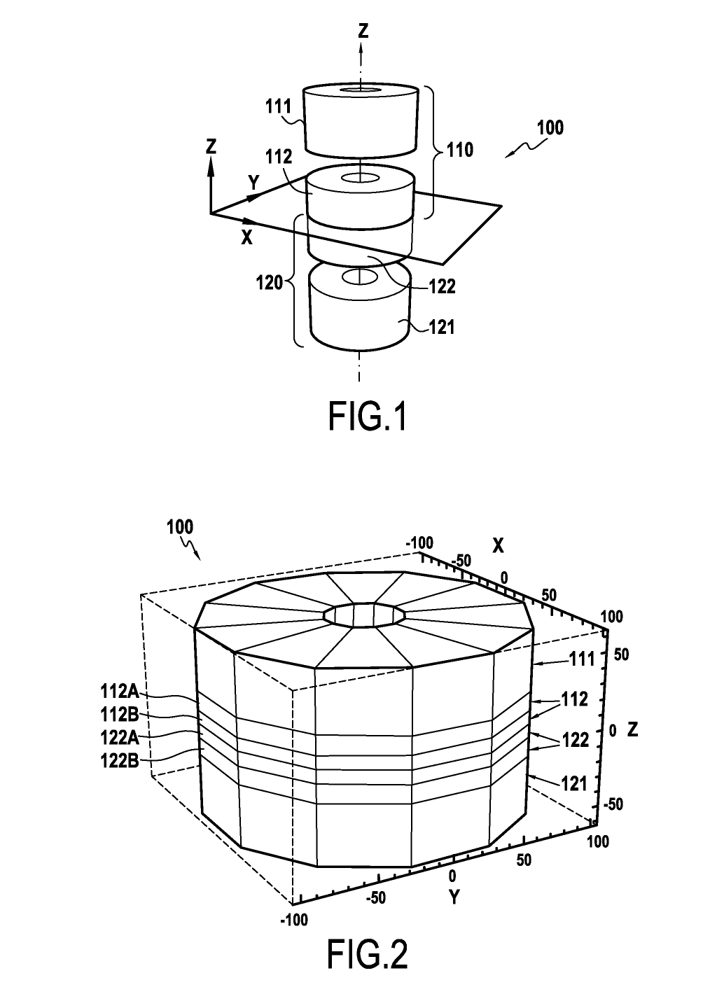

Turning to FIG. 1, there is seen an axisymmetrical magnetized structure that is an assembly of annular cylindrical slices of permanent magnets. These annular slices are aligned along a common longitudinal axis z and are symmetrical relative to a plane P. All the slices are magnetized in the same direction, which may be the longitudinal axis z of the structure or a direction at an angle to that axis z. The center of the region of interest where an intense and homogeneous field must be created is situated at the intersection of the axis z and the plane P. The overall structure is cylindrical with a central hole that extends along the axis z and provides access to the center of the region of interest.

There is more particularly seen in FIG. 1 a device 100 comprising first and second annular magnetized structures 111, 121 disposed symmetrically relative to the plane P that is perpendicular to the longitudinal axis z and contains the central area of interest, and a third annular magnetized structure 112, 122 disposed between the structures 111 and 121 and also disposed symmetrically relative to the plane P.

Thus two assemblies 110 and 120 symmetrical relative to the plane P are obtained. The assembly 110 comprises the structure 111 and the half 112 of the median structure 112, 122, while the assembly 120 comprises the structure 121 and the half 122 of the median structure 112, 122. The symmetry relative to the plane P makes it possible to cancel out all the odd terms in the expansion into regular solid spherical harmonics of the component B_{z} of the magnetic field produced in the vicinity of the center of the area of interest.

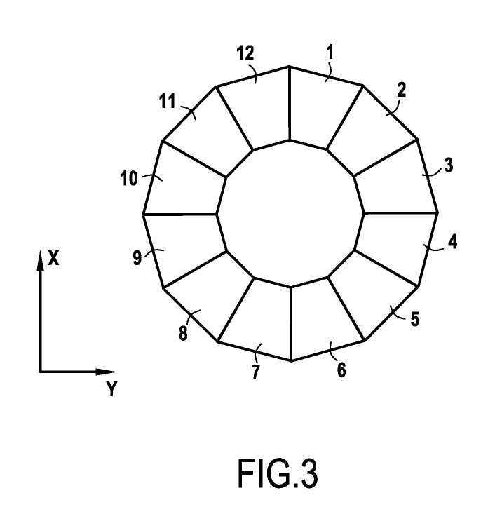

As may be seen in FIG. 2, all the annular magnetized structures 111, 121, 112, 122 are divided into components in the form of sectors identified by the reference numbers 1 to 12 in FIG. 3. The invention is however not limited to a number of sectors equal to 12 and this number could be different from 12. The use of twelve sectors in each ring constitutes a preferred embodiment with a satisfactory order of homogeneity. A lower number of sectors, for example ten sectors or even fewer, also enables useful results, but with slightly degraded homogeneity. The annular magnetized structures 111, 121, 112, 122 may be divided into more than twelve sectors to improve homogeneity further.

Generally speaking, it is advantageous to produce each annular cylindrical structure in the form of a regular polyhedral structure comprising a set of N identical segments. Each segment is thus a right-angle prism of isosceles trapezoidal section and its magnetization is parallel to the height of the prism or at a predetermined angle to that height.

Each sector-shaped elementary segment may be contiguous with the adjoining segments or not. The present invention, which eliminates or reduces adjustments after assembly, may advantageously be carried out with segments 1 to 12 that are contiguous within the same ring, as shown in FIG. 3.

The median annular magnetized structure 112, 122 is divided into slices 112A, 112B, 122A, 122B along the longitudinal axis z. These slices are thinner in the direction of the axis z than the structures 111 and 121.

All the components of the annular magnetized structures 111, 121, 112, 122 defining an axisymmetrical or quasi-axisymmetrical structure are magnetized in the same direction to create in the central area of interest a homogeneous and intense induced magnetic field at a predetermined angle between 0 and 90° to the longitudinal axis z.

A few basic concepts useful for understanding the invention are briefly described below.

Usually, the region of interest (RoI) is outside the region of the sources of magnetic field and a pseudo-scalar magnetic potential may be defined such that:

\vec{B}=−\vec{∇}Φ*

This potential satisfies the Laplace equation:

ΔΦ*=0

In the situation of interest here, the region of interest may be represented as a sphere of center that is referred to as the origin. The Laplace equation may be expressed in a system of spherical coordinates and a unique expansion of the potential into spherical harmonics may be obtained, centered at the origin. The general solution for the potential may then be written:

$${Φ}^{*} ( r , θ , φ ) = {\sum }_{l = 0}^{∞} {\sum }_{m = - l}^{l} [ {A}_{lm} {r}^{l} + {B}_{lm} {r}^{- ( l + 1 )} ] {Y}_{lm} ( θ , φ ) ,$$

where:

$${Y}_{lm} ( θ , φ ) = \sqrt{\frac{2 l + 1 ( l - m ) !}{4 π ( l + m ) !}} {P}_{l}^{m} ( cos θ ) exp ( im φ )$$

Remembering that the potential exists only in empty space, space may be divided into two areas in which the potential exists: inside the largest sphere centered at the origin that does not contain any source and outside the smallest sphere centered at the origin that contains all the sources.

If the sources are situated outside this sphere, the expansion may be written as follows:

$${Φ}^{*} ( r , θ , φ ) = \frac{1}{{μ}_{0}} \{ {Z}_{0} + {\sum }_{n = 1}^{∞} {r}^{n} [ \begin{matrix}{Z}_{n} {P}_{n} ( cos θ ) + \\ {\sum }_{m = 1}^{n} ( \begin{matrix}{X}_{n}^{m} cos ( m φ ) + \\ {Y}_{n}^{m} sin ( m φ )\end{matrix} ) \\ {P}_{n}^{m} ( cos θ )\end{matrix} ] \}$$

where the terms Zₙ are called the axial terms and the terms Xₙ^{m} and Yₙ^{m} are called the non-axial terms.

On the basis of the above equation, it may be concluded that in order to obtain a homogeneous field it is necessary to find a distribution of the source that creates a potential for which the expansion contains only the term Z₁ (provided the field is the derivative of the potential and that the term Z₀ for the field corresponds to the term Z₁ for the potential). Strictly speaking, this is impossible, but as many terms as necessary may be eliminated to obtain the required homogeneity with a given radius r since the field varies with

$${( \frac{r}{a} )}^{n}$$

where a is a constant characteristic of the geometry. In conclusion, to obtain the required homogeneity, it is necessary to eliminate the first k orders until

$${( \frac{r}{a} )}^{k + 1}$$

is sufficiently small.

It may also be deduced from the above equation that an axisymmetrical structure is advantageous in that it eliminates the non-axial terms. To obtain homogeneity of order n, the n symmetry of rotation guarantees that no non-axial term exists before order n.

Once the non-axial terms have been eliminated, the axial terms remain.

Another symmetry of interest is mirror symmetry or antisymmetry which leaves only the even (or odd) axial terms. It is then possible to eliminate arbitrarily the orders 2p by providing p+1 independent sources.

Non-linear optimization is thus possible. Moreover, the solution found may be expanded. The system may be expanded uniformly in all dimensions (constant scale factor) and made as large as possible, the homogeneity properties being unaffected and the amplitude of the magnetic field remaining constant.

It can be shown that the homogeneity properties of the field generated by a structure calculated as above vary in a perfectly predictable manner if the magnetization of all the parts is inclined in a given direction. It is realized that if one starts from a symmetrical structure allowing elimination of the non-axial terms up to order n, the orthogonal component of the magnetization introduced by the inclination generates non-axial terms from order n−2. Moreover, the modulus of the resulting field is decreased and its direction inclined.

There exist situations, notably in NMR, where it may be useful to have a magnetic field at an angle to the axis of symmetry. For example, the spiral windings cannot be used easily for an orientation of the field pointing parallel to the geometrical axis of the cylinder. With inclination of the field this type of winding becomes usable. The inclination θ₂ of the field to the axis of symmetry may be linked to the inclination θ₁ of the magnetization to the axis of symmetry by the following formulas:

$$sin {θ}_{1} = \frac{2 sin {θ}_{2}}{\sqrt{1 + 3 {sin}^{2} {θ}_{2}}} , \\ cos {θ}_{1} = - \frac{cos {θ}_{2}}{\sqrt{1 + 3 {sin}^{2} {θ}_{2}}} , \\ sin {θ}_{2} = \frac{sin {θ}_{1}}{\sqrt{1 + 3 {cos}^{2} {θ}_{1}}} , \\ cos {θ}_{2} = - \frac{2 cos {θ}_{1}}{\sqrt{1 + 3 {cos}^{2} {θ}_{1}}} ,$$

It is thus a simple matter to determine the inclination of the magnetization to impart the desired inclination to the field. This may prove particularly useful in NMR of anisotropic materials. Inclining the field at the magic angle (≈54.7°) plus rotating the magnet on its axis would make it possible to improve resolution in the same way as the MAS technique. Moreover, homogeneity may still be achieved arbitrarily. The basis may be a longitudinally magnetized design with the non-axial terms eliminated up to order n+2 to obtain homogeneity of order n after inclination of the magnetization. This is advantageous in that it is no longer necessary to spin the sample and this makes it possible to analyze fragile (for example living) subjects or bulky subjects with a high resolution.

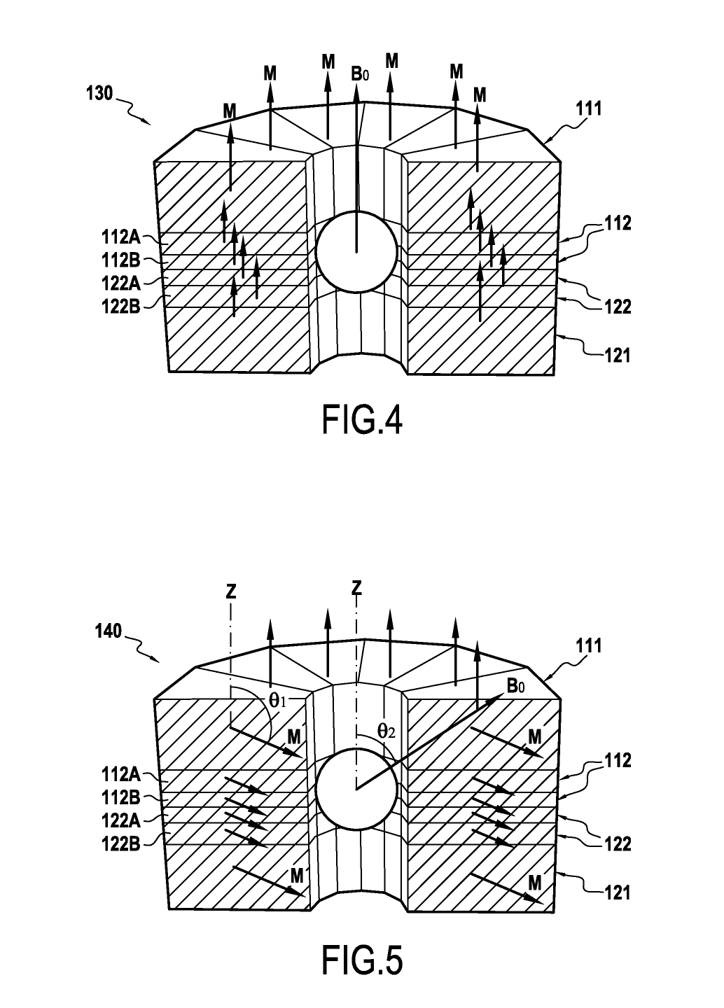

The structures of the embodiments of FIGS. 1 and 2 apply the above teaching. FIGS. 4 and 5 show two different orientations of the direction of the magnetization M of all the components and the induced magnetic field B₀ resulting from these structures always generate a homogeneous field at their center. One (structure 130, FIG. 4) creates a field B₀ parallel to its axis and the other (structure 140, FIG. 5) a field B₀ at the magic angle to the axis. These two structures 130, 140 differ from each other only in the direction of the magnetization M of the parts, as explained above, and both may be produced in the form shown in FIG. 2, for example, assembly being carried out before magnetizing the various components.

The geometry has a plane of symmetry P containing the center of the structure and orthogonal to the axis z. The axis z is the axis of symmetry of the structure that is made up of various coaxial elements of cylindrical shape pierced at their center to open up access to the center. A basic diagram of the structure may be seen in FIG. 1. The position and dimensions along z of the elements control the homogeneity (by the method of eliminating axial terms). Moreover, the plane symmetry makes it possible to eliminate one axial term in two in the expansion into spherical harmonics; thus p+1 elements are required to achieve homogeneity of order 2p (since p terms remain to be eliminated).

The perfectly cylindrical elements represented in FIG. 1 may be envisaged, but are not necessarily the most suitable for manufacture (geometrical imperfections, requirement for adjustment after assembly). In contrast, the cylinder may be approximated by a polygonal shape made up of sectors. As mentioned above, to achieve homogeneity up to order 10 (10th order first terms) when the field is inclined, the structure generating a non-inclined field must be 12th order homogeneous. For this it must have axial symmetry of order 12 to be sure of the absence of non-axial terms, which implies a dodecagon. Moreover, eliminating the axial terms requires six elements to achieve order 12.

FIG. 2 shows a geometry satisfying the various homogeneity conditions.

FIG. 4 shows the direction of the magnetization M in a structure 130 all elements of which are magnetized along the axis.

In one particular embodiment, 12th order homogeneity is obtained with a field B₀ created at the center that is along the axis and of 496 mT for a remanence of 1.3 T.

FIG. 5 shows the direction of magnetization of the various parts in a second structure 140 that has the same geometry but is magnetized at 109.47° to the axis to generate a field B₀ at its center at the magic angle (54.7°) to the axis.

In one particular embodiment, the homogeneity is reduced by the non-axial terms to the 10th order with a resultant field of 221 mT that is at the magic angle to the axis.

It is naturally possible to vary the angle θ₁ between the direction of magnetization M and the axis z to vary the angle θ₂ between the vector of the field B₀ and the axis z.

An advantage of these structures is that their elements are all magnetized in the same direction. Also, by using a sufficiently large and strong auxiliary magnet, i.e. one creating a field sufficient to saturate all the elements of the structure of the invention, it is possible to magnetize all of the structure at once. This enables assembly to be carried out with non-magnetized parts. This greatly simplifies assembly because it avoids all the forces linked to the magnetism of the parts, which may be extremely intense when assembling large parts.

The structures of the invention are thus advantageously, although not exclusively, manufactured by the following method:

a) sector-shaped components are manufactured from a magnetizable but non-magnetized material;

b) these sector-shaped components are assembled to form non-magnetized first and second annular structures 111, 121 symmetrically disposed relative to a plane P that is perpendicular to a longitudinal axis z and contains a central area of interest, and to form a median third non-magnetized annular structure 112, 122 disposed between the structures 111 and 121 and also symmetrically disposed relative to the plane P; and

c) all the components of the various non-magnetized annular structures 111, 121, 112, 122 are subjected to the action of the magnetic field of an exterior auxiliary magnet up to saturation point to magnetize all the components of the various annular structures 111, 121, 112, 122 in the same direction at a first predetermined angle θ₁ relative to the longitudinal axis z so that the permanent magnetic device produced by the method is able to create in said central area of interest a homogeneous and intense induced magnetic field at a second predetermined angle θ₂ between 0 and 90° to the longitudinal axis z.

1. A cylindrical permanent magnet device that induces in a central area of interest a homogeneous magnetic field of predetermined orientation relative to a longitudinal axis of the device, the device comprising first and second annular magnetized structures disposed symmetrically relative to a plane that is perpendicular to said longitudinal axis and that contains said central area of interest, and a third annular magnetized structure disposed between the first and second structures and also disposed symmetrically relative to said plane, the first, second, and third annular magnetized structures being each divided into a plurality of components in the form of regularly distributed identical sectors, the device being characterized in that the third annular magnetized structure is divided into at least two slices along the longitudinal axis and in that all the components of the first, second and third annular magnetized structures are magnetized in the same direction at a predetermined first angle θ₁ to said longitudinal axis to create in said central area of interest a homogeneous induced magnetic field at a predetermined second angle θ₂ to said longitudinal axis.

2. A device according to claim 1, characterized in that said predetermined second angle θ₂ is zero and all the sector-shaped components are magnetized along said longitudinal axis.

3. A device according to claim 1, characterized in that said predetermined second angle θ₂ is equal to the magic angle of 54.7° and all the sector-shaped components are magnetized in the same direction inclined at 109.47° to said longitudinal axis.

4. A device according to claim 1, characterized in that the third annular magnetized structure is divided into at least four slices.

5. A device according to claim 1, characterized in that said predetermined first angle θ₁ and said predetermined second angle θ₂ are determined by the following formulas:
$$sin {θ}_{1} = \frac{2 sin {θ}_{2}}{\sqrt{1 + 3 {sin}^{2} {θ}_{2}}} , \\ cos {θ}_{1} = - \frac{cos {θ}_{2}}{\sqrt{1 + 3 {sin}^{2} {θ}_{2}}} , \\ sin {θ}_{2} = \frac{sin {θ}_{1}}{\sqrt{1 + 3 {cos}^{2} {θ}_{1}}} , \\ cos {θ}_{2} = - \frac{2 cos {θ}_{1}}{\sqrt{1 + 3 {cos}^{2} {θ}_{1}}} ,$$

6. A device according to claim 1, characterized in that the first and second annular magnetized structures and each slice of the third annular magnetized structure are divided into at least twelve components in the form of identical sectors.

7. A device according to claim 1, characterized in that the first and second annular magnetized structures have in the direction of the longitudinal axis a thickness greater than that of each slice of the third annular magnetized structure.

8. A device according to claim 1, characterized in that the interior and exterior cylindrical walls of the first, second, and third annular magnetized structures have a polygonal section in a plane perpendicular to said longitudinal axis.

9. A device according to claim 1, characterized in that all the components of the first, second, and third annular magnetized structures are contiguous.

10. A device according to claim 1, characterized in that the interior and exterior cylindrical walls of the first, second, and third annular magnetized structures have a circular section in a plane perpendicular to said longitudinal axis to define an axisymmetrical structure.

11. A method of manufacturing a device according to claim 1, characterized in that it comprises the following steps:
a) manufacturing identical sector-shaped components from a magnetizable but non-magnetized material;
b) assembling said sector-shaped components to form non-magnetized first and second annular structures symmetrically disposed relative to a plane that is perpendicular to a longitudinal axis and contains a central area of interest, and to form a non-magnetized third median annular structure disposed between the first and second structures and also symmetrically disposed relative to said plane perpendicular to the longitudinal axis and containing the central area of interest; and
c) subjecting all the components of the first, second, and third non-magnetized annular structures to the action of the magnetic field of an exterior auxiliary magnet up to saturation point to magnetize all the components of the first, second, and third annular structures in the same direction at a first predetermined angle θ₁ relative to said longitudinal axis so that the permanent magnetic device produced by the method is able to create in said central area of interest a homogeneous and intense induced magnetic field at a second predetermined angle θ₂ to the longitudinal axis.

12. A device according to claim 2, characterized in that the third annular magnetized structure is divided into at least four slices.

13. A device according to claim 3, characterized in that the third annular magnetized structure is divided into at least four slices.

14. A device according to claim 12, characterized in that the first and second annular magnetized structures and each slice of the third annular magnetized structure are divided into at least twelve components in the form of identical sectors.

15. A device according to claim 13, characterized in that the first and second annular magnetized structures and each slice of the third annular magnetized structure are divided into at least twelve components in the form of identical sectors.

16. A device according to claim 5, characterized in that the first and second annular magnetized structures and each slice of the third annular magnetized structure are divided into at least twelve components in the form of identical sectors.

17. A device according to claim 12, characterized in that the first and second annular magnetized structures have in the direction of the longitudinal axis a thickness greater than that of each slice of the third annular magnetized structure.

18. A device according to claim 13, characterized in that the first and second annular magnetized structures have in the direction of the longitudinal axis a thickness greater than that of each slice of the third annular magnetized structure.

19. A device according to claim 14, characterized in that the first and second annular magnetized structures have in the direction of the longitudinal axis a thickness greater than that of each slice of the third annular magnetized structure.

20. A device according to claim 15, characterized in that the first and second annular magnetized structures have in the direction of the longitudinal axis a thickness greater than that of each slice of the third annular magnetized structure.

21. A device according to claim 16, characterized in that the first and second annular magnetized structures have in the direction of the longitudinal axis a thickness greater than that of each slice of the third annular magnetized structure.

22. A device according to claim 7, characterized in that:
the interior and exterior cylindrical walls of the first, second, and third annular magnetized structures have a polygonal section in a plane perpendicular to said longitudinal axis; and
all the components of the first, second, and third annular magnetized structures are continguous.

23. A device according to claim 12, characterized in that the interior and exterior cylindrical walls of the first, second, and third annular magnetized structures have a circular section in a plane perpendicular to said longitudinal axis to define an axisymmetrical structure.

24. A device according to claim 17, characterized in that the interior and exterior cylindrical walls of the first, second, and third annular magnetized structures have a circular section in a plane perpendicular to said longitudinal axis to define an axisymmetrical structure.

25. A method of manufacturing a device according to claim 12 characterized in that it comprises the following steps:
a) manufacturing identical sector-shaped components from a magnetizable but non-magnetized material;
b) assembling said sector-shaped components to form non-magnetized first and second annular structures symmetrically disposed relative to a plane that is perpendicular to a longitudinal axis and contains a central area of interest, and to form a non-magnetized third median annular structure disposed between the first and second structures and also symmetrically disposed relative to said plane perpendicular to the longitudinal axis and containing the central area of interest; and
c) subjecting all the components of the first, second, and third non-magnetized annular structures to the action of the magnetic field of an exterior auxiliary magnet up to saturation point to magnetize all the components of the first, second, and third annular structures in the same direction at a first predetermined angle θ₁ relative to said longitudinal axis so that the permanent magnetic device produced by the method is able to create in said central area of interest a homogeneous and intense induced magnetic field at a second predetermined angle θ₂ to the longitudinal axis.

26. A method of manufacturing a device according to claim 13 characterized in that it comprises the following steps:
a) manufacturing identical sector-shaped components from a magnetizable but non-magnetized material;
b) assembling said sector-shaped components to form non-magnetized first and second annular structures symmetrically disposed relative to a plane that is perpendicular to a longitudinal axis and contains a central area of interest, and to form a non-magnetized third median annular structure disposed between the first and second structures and also symmetrically disposed relative to said plane perpendicular to the longitudinal axis and containing the central area of interest; and
c) subjecting all the components of the first, second, and third non-magnetized annular structures to the action of the magnetic field of an exterior auxiliary magnet up to saturation point to magnetize all the components of the first, second, and third annular structures in the same direction at a first predetermined angle θ₁ relative to said longitudinal axis so that the permanent magnetic device produced by the method is able to create in said central area of interest a homogeneous and intense induced magnetic field at a second predetermined angle θ₂ to the longitudinal axis.

27. A method of manufacturing a device according to claim 14 characterized in that it comprises the following steps:
a) manufacturing identical sector-shaped components from a magnetizable but non-magnetized material;
b) assembling said sector-shaped components to form non-magnetized first and second annular structures symmetrically disposed relative to a plane that is perpendicular to a longitudinal axis and contains a central area of interest, and to form a non-magnetized third median annular structure disposed between the first and second structures and also symmetrically disposed relative to said plane perpendicular to the longitudinal axis and containing the central area of interest; and
c) subjecting all the components of the first, second, and third non-magnetized annular structures to the action of the magnetic field of an exterior auxiliary magnet up to saturation point to magnetize all the components of the first, second, and third annular structures in the same direction at a first predetermined angle θ₁ relative to said longitudinal axis so that the permanent magnetic device produced by the method is able to create in said central area of interest a homogeneous and intense induced magnetic field at a second predetermined angle θ₂ to the longitudinal axis.

28. A method of manufacturing a device according to claim 15 characterized in that it comprises the following steps:
a) manufacturing identical sector-shaped components from a magnetizable but non-magnetized material;
b) assembling said sector-shaped components to form non-magnetized first and second annular structures symmetrically disposed relative to a plane that is perpendicular to a longitudinal axis and contains a central area of interest, and to form a non-magnetized third median annular structure disposed between the first and second structures and also symmetrically disposed relative to said plane perpendicular to the longitudinal axis and containing the central area of interest; and
c) subjecting all the components of the first, second, and third non-magnetized annular structures to the action of the magnetic field of an exterior auxiliary magnet up to saturation point to magnetize all the components of the first, second, and third annular structures in the same direction at a first predetermined angle θ₁ relative to said longitudinal axis so that the permanent magnetic device produced by the method is able to create in said central area of interest a homogeneous and intense induced magnetic field at a second predetermined angle θ₂ to the longitudinal axis.

29. A method of manufacturing a device according to claim 16 characterized in that it comprises the following steps:
a) manufacturing identical sector-shaped components from a magnetizable but non-magnetized material;
b) assembling said sector-shaped components to form non-magnetized first and second annular structures symmetrically disposed relative to a plane that is perpendicular to a longitudinal axis and contains a central area of interest, and to form a non-magnetized third median annular structure disposed between the first and second structures and also symmetrically disposed relative to said plane perpendicular to the longitudinal axis and containing the central area of interest; and
c) subjecting all the components of the first, second, and third non-magnetized annular structures to the action of the magnetic field of an exterior auxiliary magnet up to saturation point to magnetize all the components of the first, second, and third annular structures in the same direction at a first predetermined angle θ₁ relative to said longitudinal axis so that the permanent magnetic device produced by the method is able to create in said central area of interest a homogeneous and intense induced magnetic field at a second predetermined angle θ₂ to the longitudinal axis.

30. A method of manufacturing a device according to claim 22 characterized in that it comprises the following steps:
a) manufacturing identical sector-shaped components from a magnetizable but non-magnetized material;
b) assembling said sector-shaped components to form non-magnetized first and second annular structures symmetrically disposed relative to a plane that is perpendicular to a longitudinal axis and contains a central area of interest, and to form a non-magnetized third median annular structure disposed between the first and second structures and also symmetrically disposed relative to said plane perpendicular to the longitudinal axis and containing the central area of interest; and
c) subjecting all the components of the first, second, and third non-magnetized annular structures to the action of the magnetic field of an exterior auxiliary magnet up to saturation point to magnetize all the components of the first, second, and third annular structures in the same direction at a first predetermined angle θ₁ relative to said longitudinal axis so that the permanent magnetic device produced by the method is able to create in said central area of interest a homogeneous and intense induced magnetic field at a second predetermined angle θ₂ to the longitudinal axis.
